(19) United States
(12) Patent Application Publication
(10) Pub. No.: US 2018/0374278 A1
(43) Pub. Date: Dec. 27, 2018

(54) PAYMENT TERMINAL, MANAGEMENT SYSTEM OF A PRODUCT AND/OR ASSOCIATED SERVICE, AND METHOD FOR COLLECTING THE CORRESPONDING DATA

(71) Applicant: PARKEON, Paris (FR)

(72) Inventors: Julien MOLÉ, ARBOIS (FR); David LAGNIE, OSSELLE-ROUTELLE (FR); Alexandre MAUREL, BESANCON (FR); Franck MARTINEZ, EMAGNY (FR)

(21) Appl. No.: 16/013,362

(22) Filed: Jun. 20, 2018

(30) Foreign Application Priority Data
Jun. 21, 2017 (FR) 17 55655

(51) Int. Cl. G07B 15/02; G08G 1/01; G06Q 20/18; G06Q 20/20; G06K 9/00

(52) U.S. Cl. CPC G07B 15/02; G08G 1/0137; G06K 9/00785; G06Q 20/206; G06Q 20/208; G06Q 20/18

(57) ABSTRACT

The payment terminal, arranged on the street and usable for the purchase of a product and/or a service, is designed to communicate with a remote computer server. The payment terminal is provided with a data capture device that is designed to capture traffic data relating to vehicles traveling in the vicinity of the payment terminal and/or to capture environmental data relating to the quality of the environment near the terminal, wherein the payment terminal is designed to send the captured data to the computer server.

### TECHNICAL FIELD

The present invention relates to the field of payment terminals located in a public area with open access for the sale of a product and/or service.

### BACKGROUND

FR 2 968 814 A1 discloses a parking ticket machine that is designed to provide a paid service for sending an SMS (Short Message System), MMS (Multimedia Messaging Service) or e-mail, wherein the message may possibly be accompanied by an image, a video or sound content captured by a capturing device of the parking ticket machine, or received by the parking ticket machine via a communication device located a short distance from the parking ticket machine.

### SUMMARY OF THE INVENTION

One of the objects of the invention is to propose a payment terminal offering additional functionality.

For this purpose, the invention proposes a payment terminal that is arranged on the street and may be used for the purchase of a product and/or a service, wherein the payment terminal is designed to communicate with a remote computer server, and wherein the payment terminal is provided with a data capture device that is designed to capture traffic data relating to vehicles circulating in the vicinity of the payment terminal and/or to collect environmental data relating to the quality of the environment in the vicinity of the payment terminal, wherein the payment terminal is designed to send the captured data to the computer server.

A payment terminal arranged on the street and connected to a computer server may advantageously serve as a support for an environmental data or traffic data sensor, which may be transmitted in a simple manner to the computer server and then to a recipient such as a supervisory authority or a pollution control authority. In addition, it is possible to collect data from multiple payment terminals thus making it easy to collect data over a wide area.

The payment terminal may comprise one or more of the following optional features, taken singly or in any technically feasible combination:
the payment terminal may be a parking ticket machine that is designed to issue parking tickets,
the data capture device is designed to capture biometric data of pedestrians located in a supervised area near the payment terminal, wherein the monitored area is at least partially distinct from the area of use of the payment terminal in which a user stands to use the payment terminal,
the data capture device comprises at least one biometric data sensor chosen from among a fingerprint sensor, a palm recognition sensor, an eye recognition sensor, a facial recognition sensor and a vascular recognition sensor,
the data capture device comprises at least one traffic data sensor chosen from among a speed detector, a red-light running detector, a pedestrian priority refusal detector, a vehicle priority refusal detector, a license plate reading device and a traffic surveillance camera that is oriented to monitor road traffic on a roadway located near the payment terminal,
the data capture device comprises at least one environmental data sensor chosen from among a brightness sensor, a noise sensor, an atmospheric temperature sensor, an atmospheric pressure sensor, a hygrometry sensor, a rain sensor, an allergen sensor, a particle detector and a gas sensor capable of detecting the concentration in air of one or more gases, in particular the concentration of CO2 in the air,
the terminal further comprises an optical reading device designed to read an optical code,
the terminal further comprises an additional communication device designed to communicate with a communicating electronic device located near the payment terminal, via a wireless or wired connection,
the terminal further comprises a sound and/or visual signal generator designed to generate a sound and/or visual signal that is perceptible by a pedestrian or a driver of a vehicle.

The invention also relates to a management system comprising a plurality of payment terminals as defined above, a computer server communicating with each payment terminal, wherein the computer server is designed to receive the data captured from the payment terminals by the data capture devices, as well as to send the captured data to at least one recipient and/or to send instructions to the payment terminals as a function of the data captured.

The invention also relates to a method for data collection from at least one payment terminal that is arranged on the roadway, and that may be used for the purchase of a product and/or a service, wherein each payment terminal belonging to a product and/or service management system comprises a computer server communicating with each payment terminal, wherein the data collection method comprises the capture of traffic data relating to vehicles circulating in the vicinity of the payment terminal and/or environmental data relating to the quality of the environment near the payment terminal, and the transmission by the terminal of the captured data to the computer server.

### BRIEF DESCRIPTION OF DRAWINGS

The invention and its advantages will be better understood on reading the description which follows, given solely by way of a non-limiting example, and with reference to the appended drawings, wherein:

FIG. 1 shows a schematic overview of a product and/or service management system comprising a plurality of payment terminals arranged on the street;

FIG. 2 shows a flowchart illustrating steps of a data collection method implemented using the management system.

### DETAILED DESCRIPTION OF PREFERRED EMBODIMENTS

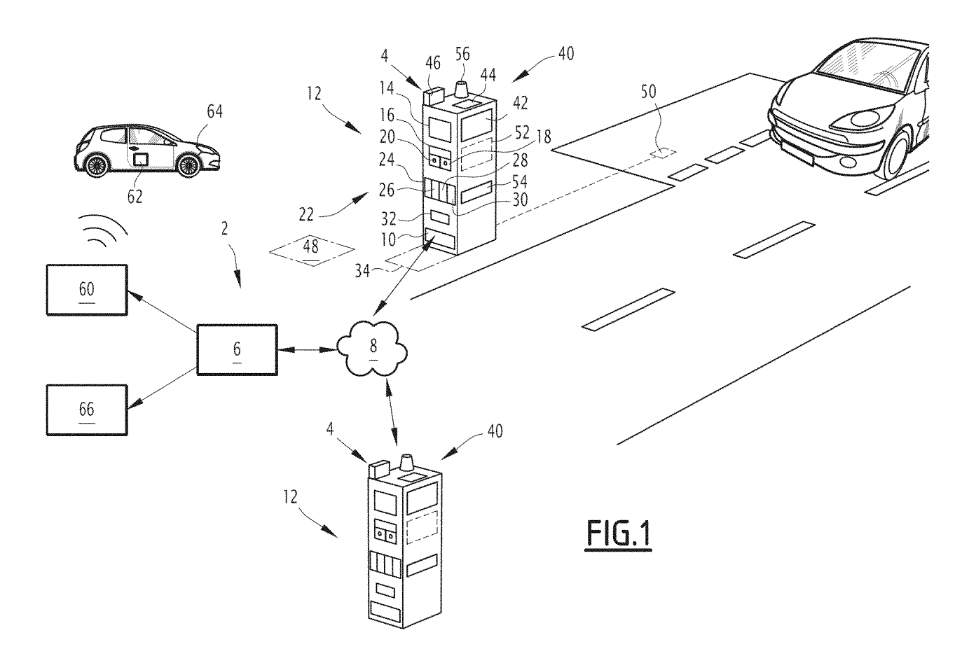

As illustrated in FIG. 1, the product and/or service management system 2 is designed to allow users to purchase a product and/or service.

The management system 2 comprises a plurality of payment terminals 4, wherein each payment terminal 4 is placed by the street, and a computer server 6 communicates with each of the payment terminals 4 via a communication network 8.

In the present description, a “user” designates a person using a payment terminal 4 of the management system 2 for the purchase of a product and/or a service. A “pedestrian” or “individual” means a person who does not use a payment terminal 4 for the purchase of a product and/or service, but who may be located on the street near the payment terminal 4.

The “street” comprises the roadway reserved for car traffic, parking spaces reserved for vehicle parking, and sidewalks and pedestrian spaces reserved for pedestrian traffic.

In the illustrated example, each payment terminal 4 is a parking ticket machine. Each payment terminal 4 is thus designed to issue parking tickets, allowing the user to park their vehicle in a parking space.

In another example, each payment terminal 4 is designed to issue tickets for using public transport (bus, subway, tram, train . . . ).

Each payment terminal 4 is in communication with the computer server 6 for the exchange of data.

Each payment terminal 4 here comprises a communication device 10 designed to communicate with the computer server 6 via the communication network 8. The payment terminal 4 communicates with the computer server 6 via the communication device 10.

The communication network 8 is a wired or wireless communication network. The communication network 8 is, for example, a wired telephone network, a mobile telephone network (GSM, UMTS, LTE, LTE Category 4, LTE Category 1, LTE Category M1, LTE Category NB1 . . . ), a computer network (LAN, WAN), the Internet, a local network (WIFI, Bluetooth, Lora, Lifi, Zigbee, Z-Wave, Dust, ANT+, NFC) . . . .

Each payment terminal 4 is interactive to allow the user to interact with the payment terminal 4, in particular to select a product and/or a service.

Each payment terminal 4 comprises a human-machine interface device 12 allowing the user to interact with the payment terminal 4 for the purchase of a product and/or a service. For example, the human-machine interface device 12 enables the user to select a product and/or a service that he wishes to purchase.

The human-machine interface device 12 comprises, for example, an image display device 14, a pointing device 16 for selecting fields and/or buttons in a graphical user interface, an alphanumeric keyboard 18 for entering alphanumeric characters and/or one or more physical buttons. The display device 14 is, for example, a screen, in particular a touch screen to allow pointing and/or entering data directly via the screen.

Each payment terminal 4 comprises a payment device 22 enabling a user to pay for a product and/or a service via the payment terminal 4.

The payment device 22 comprises, for example, an electronic payment terminal 24 designed for card payment, in particular for smart cards, in particular for bank or private cards, a money selector 26 designed for payment with one or more coins, a bank note reader 28 designed for payment with one or more bank notes and/or a contactless payment terminal 30 designed for payment with an electronic device (smart card, smartphone . . . ) with contactless communication between the contactless payment terminal and the electronic device, for example by near field communication (NFC).

Each payment terminal 4 may optionally comprise a printing device 32 for printing a receipt, for example a parking ticket.

Each payment terminal 4 has an area of use 34 which is the area in which a user must stand in order to use the payment terminal 4, and, in particular, to use the human-machine interface device 12 of the terminal 4 and the payment device of the payment terminal 4. The area of use 34 is thus represented by an area of one to two square meters located in front of the payment terminal 4.

Each payment terminal 4 is provided with a data capture device 40 that is designed to collect traffic data relating to vehicles traveling on the roadway near the payment terminal 4 and/or to collect environmental data relating to the quality of the environment near the terminal 4.

Each payment terminal 4 is designed to send the data captured by the data capture device 40 to the computer server 6, in this case via the communication device of the payment terminal 4.

The data capture device 40 is designed to capture data independently of the purchase of a product and/or service via the payment terminal 4.

The data capture device 40 is designed to capture data automatically even without interaction of a user with the payment terminal 4 for the purchase of a product and/or a service.

The data capture device 40 is designed to capture data even when no user is using the payment device 22.

The data capture device 40 comprises at least one data sensor for sensing traffic data or environmental data. Each data sensor of the data capture device is borne by the payment terminal 4.

In an exemplary embodiment, the data capture device 40 comprises at least one traffic data sensor 42 for capturing traffic data.

Road traffic data are data relating to the movement of vehicles on the roadway and/or vehicles parked in the parking spaces.

Each traffic data sensor 42 is designed and positioned on the payment terminal 4 to collect data relating to vehicles traveling on the roadway and/or data relating to vehicles parked in the parking spaces.

Each circulation data sensor 42 is, for example, chosen from a speed detector designed to measure the speed of vehicles, a red-light running detector designed to detect when a vehicle runs a red light, a pedestrian priority refusal detector to detect when a vehicle denies priority to a pedestrian, especially on a pedestrian crossing, a license plate reading device designed to automatically read the number plates of vehicles traveling on the roadway, a traffic surveillance camera oriented to monitor road traffic on a roadway located near the terminal 4.

Optionally, each traffic data sensor 42 is further designed to monitor the presence of parked vehicles, for example by capturing images and analyzing the images for the detection of parked vehicles.

In one exemplary embodiment, the data capture device 40 comprises at least one environmental data sensor 44, i.e. for data relative to the environment around the payment terminal 4 (brightness, noise, temperature, pressure, hygrometry, rainfall, presence of allergens in the air, presence of certain gases in the air, presence of particles in the air . . . ).

Each environmental data sensor 44 is, for example, selected from a brightness sensor, a noise sensor, an atmospheric temperature sensor, an atmospheric pressure sensor, a hygrometry sensor, a rain sensor, an allergen detector, a particle detector, and a gas detector capable of detecting the concentration in air of one or more gases, in particular the concentration in air of CO₂.

When the payment terminal 4 is located on the public roadway where pedestrians pass, it forms a suitable support for an environmental data sensor 44 which may thus measure environmental quantities such as they are actually perceived by pedestrians.

Optionally, the payment terminal 4 comprises at least one biometric data sensor 46. Each biometric data sensor 46 is designed to acquire biometric data of an individual or pedestrian located near the payment terminal 4.

Each biometric data sensor 46 is, for example, chosen from a fingerprint sensor, a palmprint sensor (i.e. the impression of the palm of an individual's hand), an eye recognition sensor (i.e. recognition of the iris of an individual), a facial recognition sensor (i.e. recognition of the face of an individual) . . . .

A facial or eye recognition sensor comprises, for example, a camera arranged on the payment terminal 4 in order to capture images of the face and/or the iris of individuals located near the payment terminal 4, in particular outside the area of use, and a recognition module designed to identify one or more fingerprints or eyes from an image captured by the camera.

In one exemplary embodiment, the payment terminal 4 comprises at least one biometric data sensor 46 positioned to capture biometric data of an individual located in a surveillance area 48 at least partly distinct from the area of use 34. The biometric data sensor is thus positioned, in particular, to capture biometric data of an individual located outside the area of use of the payment terminal 4. Thus, the payment terminal 4 makes it possible to monitor an area located around the terminal payment 4, including outside the area of use.

The payment terminal 4 located on the street forms a suitable support for a biometric data sensor 46, for example for searching for individuals wanted by law enforcement.

Optionally, each payment terminal 4 carries a vehicle presence sensor and/or is in communication with at least one vehicle presence sensor 50 that is designed to detect the presence of a vehicle in a parking space located near the payment terminal 4.

This allows, for example, the payment terminal 4 to report available parking spaces near this payment terminal 4.

Optionally, the payment terminal 4 comprises at least one additional communication device 52 for exchanging data with an electronic device located near the payment terminal 4.

The additional communication device 52 is designed for wireless or wired communication. An additional wireless communication device 52 is, for example, designed for communication according to at least one communication protocol selected from WIFI, Bluetooth and LORA, for example at the frequency of 433 MHz. An additional communication device 52 using wire is, for example, in the form of a connector for connecting an electronic device to the payment terminal 4, for example, a USB connector.

Optionally, the payment terminal 4 further comprises at least one optical reading device 54 designed to read an optical code. An “optical code” in this case designates an image present on a physical medium (drawing, map, sheet of paper, screen of a smartphone), and containing coded information. An optical code is for example a barcode or a matrix code also called “QR code”.

The reading of the optical code makes it possible, for example, to interrogate the computer server 6 in order to retrieve information relating to this optical code and to transmit it to the individual, by displaying and/or printing this information and/or by communicating this information to an electronic device of the individual.

Optionally, each payment terminal 4 comprises at least one light signal generator 56 designed to generate a light signal that is perceptible to an individual located near the payment terminal 4. Each light signal generator 56 is borne by the terminal of payment 4.

Each light signal generator 56 is, for example, chosen from a rotating beacon, an image projector to project an image onto a surface (floor, wall, etc.), a luminous pattern placed on the payment terminal 4, a light panel for the display of messages or bright pictograms.

Each light signal generator 56 is distinct from the human-machine interface device 12 serving the user for the purchase of a product and/or a service.

Each light signal generator 56 is active independently of the human-machine interface device 12.

Each light signal generator 56 is designed to generate a light signal that is perceptible to a user outside the area of use.

In particular, in one exemplary embodiment, each light signal generator 56 is designed for the generation of a light signal that is perceptible to the driver of a vehicle traveling on a roadway located near the payment terminal 4.

Each payment terminal 4 is designed to send data relating to the purchase of a product and/or a service, as well as data captured by the data capture device 40, to the computer server 6, via the communication device 10.

Where appropriate, each payment terminal 4 is designed to send data acquired by each biometric data sensor 48, by vehicle presence sensors 50, by the additional communication device 52 and/or by the optical reader device 54.

The computer server 6 is designed to process the data sent by each payment terminal 4.

The data provided by several payment terminals 4 may be processed individually in the case of data that are independent of each other, or collectively when data are dependent on each other.

By way of example, data relating to excess speed detected by a speed radar arranged on a payment terminal 4 are specific to this payment terminal 4 and independent of other data captured by other payment terminals 4, while data relating to a traffic jam detected by several payment terminals 4 are dependent, because they make it possible to determine the length of the traffic jam.

The computer server 6 is designed to send data captured by one or more payment terminals 4 to one or more recipients, in particular the traffic data and the environmental data captured by the data capture device 40.

For example, the computer server 6 is designed to send traffic data to one or more road traffic data providers 60 transmitting data to on-board electronic devices 62 in vehicles 64 and/or to one or more authorities 66 in charge of traffic regulation and/or monitoring.

Road traffic data comprise, for example, the location of traffic jams, the presence of road works, the presence of speed cameras, the passing of a priority vehicle, the maximum authorized speed . . . .

For example, each traffic data provider 60 broadcasts road traffic data via a radio signal transmitted to vehicles equipped with an on-board electronic device 62 capable of receiving this radio signal, for example a GPS receiver.

For example, each traffic data provider 60 may use the traffic data captured by the data capture device of one or more payment terminals 4 to send corresponding information to the vehicles.

Information may relate, for example, to an event requiring particular vigilance on the part of the driver (road incident, a road accident, road works on the road or on the roadside, the presence of a class on a school outing . . . ).

Each traffic data provider 60 may, for example, send each vehicle a speed limitation signal and/or a braking signal, so that the vehicle automatically limits its speed and/or automatically brakes to take into account an incident, an accident or an event on the road.

Optionally or alternatively, the computer server 6 may be designed to send data captured by the data capture device 40 from one or more payment terminals 4 to one or more authorities 66, e.g. the police and/or rescue services.

In one particular example, the computer server 6 is designed to send traffic data to the police relating to a traffic law infringement detected by a traffic data sensor of a payment terminal 4. The offense will be punished.

In one particular example, the computer server 6 is designed to send data relating to a road event to the police. The police may thus send relief to possible victims of an accident.

In one particular example, the computer server 6 is designed to send environmental data to an environmental control authority. The latter may, for example, take measures to temporarily limit the maximum authorized speed.

Optionally, the computer server 6 is designed to send instructions to one or more payment terminals 4 for the generation of a light signal by the, or each, payment terminal 4, using the light signal generators of the payment terminals.

The computer server 6 is designed to control the generation of light signals relating to a programmed event previously recorded in the computer server 6, or an event detected by one or more payment terminals using the data capture devices.

The computer server 6 includes a programming device for programming programmed events. The programming device is, for example, accessible by one or more administrative authorities to signal a particular event.

A programmed event is, for example, a school trip scheduled at a specific time and following a particular route on the road.

In such a case, the computer server 6 is advantageously designed to control the payment terminals 4 located on the programmed path for the generation of visual signals perceptible by drivers of vehicles in order to encourage them to be cautious and/or temporarily reduce their speed.

Scheduled events may be, for example, work on the road or the side of the road, an event that may disrupt road traffic or a cultural event that may be of interest to pedestrians or vehicle drivers. This allows, for example, a city authority to communicate via the payment terminals 4.

A detected event may be, for example, a road event (accident, incident . . . ) requiring increased vigilance on the part of drivers of vehicles traveling on the road, or excessive pollution resulting in a limitation of the speed of vehicles.

The computer server 6 may be, for example, designed for the sending of data by one or more payment terminals 4 provided with an additional communication device, to communicating electronic devices of pedestrians present near these payment terminals 4.

The data sent to pedestrians may be, for example, in the form of information indicating an event (incident, accident, pollution alert, event, cultural event . . . ).

The payment terminals 4 may thus be used as an information dissemination system for pedestrians. They allow effective dissemination of information because of their dense network on the public roadway, allowing reliable transmission of information because of their proximity to the pedestrians.

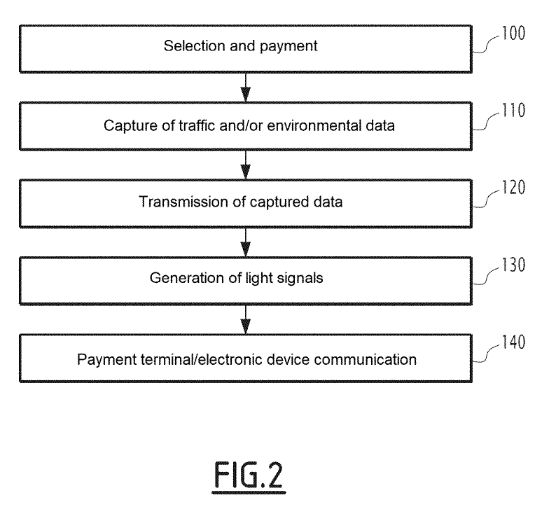

The operation of the management system 2 is now described with reference to FIG. 2 which shows a flowchart of a computer-implemented data collection method.

In payment step 100, a user uses a payment terminal 4 of the management system 2 to select and pay for a product or a service.

In data capture step 110, the data capture device of each payment terminal 4 captures traffic data and/or environmental data, and the payment terminal 4 sends this data to the computer server 6.

In transmission step 120, the computer server 6 sends the captured and optionally processed data to one or more recipients. The captured data is sent to each recipient according to the nature of the captured data.

When processed traffic data is sent to road traffic data providers 60 or authorities 66, wherein these providers and authorities may take action, for example by sending traffic information to vehicles, for the punishment of traffic offenses, for the dispatch of emergency assistance to the scene of an incident or an accident, for the implementation of a speed limit . . . .

In signaling step 130, the computer server 6 sends instructions to one or more payment terminals 4 for the generation of visual signals for pedestrians or drivers of vehicles traveling on the roadway.

Each signal generated may be, for example, an intermittent light signal, a hologram, a pictogram, an image projected on a surface . . . .

The signals generated may signal an event detected by one or more payment terminals 4 (slowdown, traffic jam, accident, roadworks) or a programmed event (school trip, event . . . ).

In information step 140, at least one payment terminal 4 communicates with at least one pedestrian's portable electronic device.

For example, a pedestrian may interrogate a payment terminal 4 using his portable electronic device. In this case, the payment terminal 4 provides the requested information from its memory or by querying the computer server 6 if the information is not available in its local memory.

In addition, a pedestrian may signal an event to a terminal 4 using their portable electronic device. In this case, the payment terminal 4 can transmit the data provided by the pedestrian to the computer server 6 which can transmit the data to other payment terminals 4 so that these payment terminals 4 may broadcast the information to other pedestrians via their communication device.

This communication channel may also be used for the dissemination of information to pedestrians by entering information into the computer server 6 and requesting the dissemination of this information via one or more payment terminals 4, which then form information dissemination relays.

This information may be, for example, related to an event, a demonstration, pollution . . . .

The use of payment terminals 4 located on the street and connected to a computer server 6, for collecting traffic data relating to the roadway near the payment terminals 4, or to the environment near the payment terminals 4, allows the collection of relevant data over the entire area covered by the payment terminals 4 of the product and/or service management system 2.

The payment terminals 4 distributed in different places make it possible to collect the information in these different places. In addition, they are placed near pedestrians and often traffic lanes, particularly with regard to parking ticket machines.

These payment terminals 4 can represent a dense network for the collection of a large amount of data which increases the accuracy, especially when it is data relating to traffic (slowing down, traffic jam) or atmospheric pollution.

Optionally, these payment terminals 4 may be used as signal terminals for generating visual signals to pedestrians and/or vehicle drivers, when they are equipped with a corresponding signal generating device. They may thus serve as an information dissemination terminal.

Since the payment terminals 4 are connected to a computer server 6, the data captured by the payment terminals 4 may be transmitted to the computer service via a communication network 8 connecting the payment terminals 4 to the computer server 6.

1. Payment terminal arranged on the street and usable for the purchase of a product and/or a service, wherein the payment terminal is designed to communicate with a remote computer server, wherein the payment terminal is provided with a data capture device that is designed to capture traffic data relating to vehicles traveling in the vicinity of the payment terminal and/or to collect environmental data relating to the quality of the environment near the payment terminal, wherein the payment terminal is designed to send the captured data to the computer server.

2. Payment terminal according to claim 1, wherein the payment terminal is a parking ticket machine designed to issue parking tickets.

3. Payment terminal according to claim 1, wherein the data capture device is designed to capture biometric data of pedestrians located in a monitored area near the payment terminal, wherein the monitored area is at least partially distinct from an area of use of the payment terminal), and in which a user stands in order to use the payment terminal.

4. Payment terminal according to claim 1, wherein the data capture device comprises at least one biometric data sensor selected from among a fingerprint sensor, a palmprint sensor, an eye recognition sensor, a facial recognition sensor and a vascular recognition sensor.

5. Payment terminal according to claim 1, wherein the data capture device comprises at least one traffic data sensor selected from among a speed detector, a red-light running detector, a pedestrian priority refusal detector, a vehicle priority refusal detector, a license plate reader and a road traffic monitoring camera oriented to monitor road traffic on a roadway located near the payment terminal.

6. Payment terminal according to claim 1, wherein the data capture device comprises at least one environmental data sensor selected from among a brightness sensor, a noise sensor, an atmospheric temperature sensor, an atmospheric pressure sensor, a hygrometry sensor, a rain sensor, an allergen sensor, a particle detector and a gas sensor capable of detecting the concentration in air of one or more gases, in particular the concentration in air of CO₂.

7. Payment terminal according to claim 1, further comprising an optical reading device (54) designed to read an optical code.

8. Payment terminal according to claim 1, further comprising an additional communication device designed to communicate with a communicating electronic device located near the payment terminal 4, via a wireless or wired link.

9. Payment terminal according to claim 1, further comprising a generator of sound and/or visual signals designed to generate a sound and/or visual signal that is perceptible to a pedestrian or the driver of a vehicle.

10. Management system for a product and/or a service, wherein the management system comprises a plurality of payment terminals according to claim 1, wherein a computer server is in communication with each payment terminal, wherein the computer server is designed to receive the data captured by the data capture devices of the payment terminals, as well as to send the captured data to at least one recipient and/or to send instructions to the payment terminals as a function of the captured data.

11. Method of collecting data from at least one payment terminal arranged on the road and usable for the purchase of a product and/or a service, wherein each payment terminal belonging to a product and/or service management system comprising a computer server in communication with each payment terminal, and wherein the data collection method comprises:
the capture of traffic data relating to vehicles moving near the terminal 4 and/or environmental data relating to the quality of the environment near the terminal; and
the transmission of the captured data to the computer server via the payment terminal.
